(19) United States
(12) Patent Application Publication
(10) Pub. No.: US 2015/0122619 A1
(43) Pub. Date: May 7, 2015

(54) ACTUATION OF A BODY-BORNE SWITCH BY A BODY GESTURE

(71) Applicant: Riccardo Brun del Re, Ottawa (CA)

(72) Inventor: Riccardo Brun del Re, Ottawa (CA)

(21) Appl. No.: 14/527,761

(22) Filed: Oct. 29, 2014

(30) Foreign Application Priority Data
Oct. 29, 2013 (CA) 2831523

(51) Int. Cl. H01H 21/26; H01H 3/14

(52) U.S. Cl. CPC H01H 21/26; H01H 3/14; H01H 2221/016
USPC 200/86.5

(57) ABSTRACT

A wearable or body-borne switch is actuated by a body gesture. The switch is coupled to a mechanical linkage that links two distinct body locations. Specific body gestures cause changes in the distance between the two body locations, inducing forces within the linkage, and, in turn, actuating the switch. The switches are actuated without the need for manual operation by the user, special electronic processors, sensors, motors, batteries, or the like.

### CROSS-REFERENCE TO RELATED APPLICATION

This application claims the benefit of and priority to Canadian Patent Application No. 2,831,523 filed Oct. 29, 2013 the entirety of which is incorporated herein by reference.

### TECHNICAL FIELD

The present invention is in the field of body-borne mechanical devices. More specifically, the invention is in the field of mechanical gesture-control such as a mechanical system that uses human body gestures to effect changes in the system's state.

### BACKGROUND OF THE INVENTION

The present invention represents a body-borne apparatus that allows a wearable or otherwise body-borne switch, latch, or other actionable mechanical system, to be actuated by a specific body gesture that is executed by the user/wearer, without the need for ordinary manual actuation of the switch by the user/wearer. The invention further provides for the actuation of specific foot-borne locomotion-assist devices that possess two stable configurations (‘down’ and ‘up’) and which therefore act as a generalized switch, described in US 2014/0298679 A1 which is incorporated herein by reference in its entirety.

The switches of the present invention may be embodied in many variants that utilize many different body locations, including fingers, arms, head, neck, legs, feet, etc. In consequence it is not practical to fully describe all possible variants of the invention. Instead, in what follows, the invention will be illustrated using simple examples that are centered on the lower extremities and that operate by way of specific foot and leg gestures.

The choice of a foot-based variant of the invention is significant. This embodiment was originally conceived to supplement a movable spring that is attached to the foot/shoe further described in US 2014/0298679 A1.

The movable spring represents a locomotion-assist device that can be oriented in one of two orientations, ‘down’ or ‘up’, wherein the ‘down’ orientation places the locomotion-assist assembly (for example a spring) below the sole of the user's shoe, thus enabling spring-assisted locomotion. The ‘up’ orientation places the locomotion-assist assembly above the sole of the user's shoe, enabling ordinary locomotion as with an ordinary shoe. The orientation of the locomotion-assist assembly of the prior invention is established by way of a bi-stable swivel-plate system that has characteristics of a mechanical switch.

The present invention was originally conceived as a means to enable the user to change the orientation state of the locomotion-assist assembly of the prior invention via a foot gesture. Specifically, the present invention was conceived to allow the spring assembly of the prior invention to be moved from ‘down’ to ‘up’ orientation and vice versa by way of foot gestures. This provides convenient ‘hands-free’ operation of the spring assembly.

This background describes the special importance of the foot variant of the present invention. However it should be understood that the present invention is not restricted to the foot or to the use of a foot gesture. The present invention is generally applicable and can be embodied in any number of variants in which it is advantageous to change the state of a wearable switch or latch by way of a body gesture.

This also illustrates that the term ‘switch’ in this disclosure should be understood in a very general manner. Here, ‘switch’ will be used to mean any two-way switch, toggle, button, latch, lever, or any mechanical system that possesses two primary configuration states. Although the switch is fundamentally mechanical in nature, it should be understood that the switch may alter the state of any arbitrary sub-system, either mechanical or electrical, to which it is coupled. For example, mechanical switches are commonly used to activate or deactivate (turn ‘on’ or ‘off’) electrical devices.

In order to understand the foot-based variants of the invention, the following anatomical terms are useful.

Forefoot—the upper-front portion of the foot,

Metatarsal bones—the long bones of the forefoot,

Midfoot—the middle portion of the foot, including the arch.

Hindfoot—the heel and ankle.

Plantarflexion—extension of the forefoot in the frontward and downward direction. This is performed by rotation of the ankle in the forward and downward direction. From a standing position, plantarflexion lifts the heel off the ground.

Dorsiflexion—retraction of the forefoot into the upward and backward direction. This is performed by rotation of the ankle in the upward or backward direction. From a standing position, dorsiflexion lifts the forefoot off the ground.

Medial malleolus—the bony protuberance found on the inside of the ankle. This is the approximate location of the pivot point about which the foot rotates about the ankle

### SUMMARY OF THE INVENTION

The invention uses two locations on the user's body, such as locations on the fingers, elbows, feet, legs, hips, wrists, arms, neck, head, or any other body part. In one embodiment, the first body location is situated at the hindfoot, on a user or on the user's shoe and the second body location is situated on the user's ankle or shin.

The two body locations are fitted with a direct mechanical linkage such as a chain, cable, rope, push rod or any other mechanical linkage in such a way that specific body gestures create forces in the mechanical linkage. A mechanical switch is coupled to the mechanical linkage in such a way that the forces in the linkage actuate the switch. The gesture has to act on at least one body part and be sufficiently pronounced to actuate the switch.

The examples to be elaborated below are centered on the foot. The mechanical switch is situated near the heel of the shoe, constituting the first body location of the invention. The second body location is the user's ankle or the user's leg above the calf and under the user's knee. In this illustrative variant of the invention, the relevant gesture is the raising and lowering of the forefoot (dorsiflexion and plantarflexion respectively). These gestures cause changes in the distance between the heel and the lower leg, thus creating forces on the mechanical linkage, which in turn, actuates the switch.

Practical embodiments of the invention may require the use of straps, pads, buckles, harnesses, or other wearable artifices at the two body locations in order to create stable reference points for the action of the mechanical linkage and to ensure user comfort. In addition, the invention may require the use of housings, conduits, harnesses, gears, pulleys, and levers to efficiently translate the forces induced by the body gesture into the mechanical linkage and subsequently to the switch.

The purpose of the switch actuation is to change the state of the generalized switch which may include mechanical or electrical sub-systems. In the described foot embodiment of the invention the switch is embodied in a bi-stable mechanical lever that raises or lowers a spring designed to assist human locomotion.

The invention allows for the actuation of a body-borne switch without ordinary, direct manual manipulation of the switch by the user. Instead the invention allows for the user to actuate the switch by performing a specific gesture, at the user's discretion. The invention enables the mechanical forces generated by the body gesture to be directly responsible for actuation of the switch; no sensors, bio-electrodes, inertial detectors, motion-detectors, motors, batteries, logic processors etc are required.

### BRIEF DESCRIPTION OF THE DRAWINGS

The invention can be applied to many different locations on the body. However in order simplify the disclosure, the figures illustrate embodiments on the foot or shoe.

The accompanying figures, where like reference numerals refer to identical or functionally similar elements throughout the separate views and which, with the detailed description below, are incorporated in and form part of the specification, further illustrate various embodiments and explain various principles and advantages all under the present invention. Other features that are considered as characteristic for the invention are set forth in the appended claims. As required, detailed embodiments of the present invention are disclosed; however, the disclosed embodiments are merely exemplary of the invention, which can be embodied in various forms. Therefore, specific structural and functional details disclosed are not to be interpreted as limiting, but merely as a basis for the claims and as a representative basis for teaching one of ordinary skill in the art to variously employ the present invention in virtually any appropriately detailed structure. Further, the terms and phrases used are not intended to be limiting; but rather, to provide an understandable description of the invention.

While the specification concludes with claims defining the features of the invention regarded as novel, it is believed that the invention will be better understood from a consideration of the following description with the drawing figures, in which like reference numerals are carried forward. The figures of the drawings are not drawn to scale.

FIG. 1 shows a simplified model of the human lower leg and foot. The figure illustrates locations, A and D on the ostensible ‘foot’ and B and C on the ostensible ‘leg.’ FIGS. 1a, 1b and 1c show how two ‘gestures’ create changes in the distance between AB and CD FIG. 1a shows the foot at rest. FIG. 1b represents a simplified model for plantarflexion. FIG. 1c is a simplified model for dorsiflexion.

FIG. 2 illustrates a first embodiment of the invention, based on the models illustrated in FIG. 1. FIG. 2a shows a generalized switch, in the form of a lever 10 attached by connection 11 to one end of a mechanical linkage 12 such as a chain or a rope whose other end is connected to a second location 13 that is secured to the user's ankle by strap 14. FIG. 2b shows how the lever 10 can be switched from a ‘down’ orientation to an ‘up’ orientation by dorsiflexion of the user's foot i.e. by lifting the forefoot toward the knee and shin thereby inducing tension in linkage 12. FIG. 2c illustrates how plantarflexion has no effect on the switch because linkage 12 slackens in this case and exerts no appreciable force on lever 10.

FIG. 3 illustrates a second embodiment of the invention based on the ideas illustrated in FIG. 1. FIG. 3a illustrates a generalized switch, in the form of a lever 10 attached by connection 11 to one end of a push-rod 16. The push-rod is housed by tubular housings 15, 17. The push rod's other end is housed within housing 17 which is connected to a second body location 13 secured to the user's ankle by strap 14. FIG. 3b illustrates how dorsiflexion has no effect on the switch because in this case, push rod 16 withdraws from housing 17 and no appreciable force is induced on the push-rod 16 or the lever 10. FIG. 3c shows how the lever 10 can be switched from the ‘up’ orientation to the ‘down’ orientation by plantarflexion of the user's foot i.e. by extending the forefoot downward and away from the knee and shin thereby inducing compression in the push rod 16 and, by association lever 10.

FIG. 4 illustrates a third embodiment of the invention which is based on FIG. 3. In this embodiment, lever 10, acting as a generalized switch is configured in a manner that allows a locomotion-assisting device (not illustrated) to intervene between the user's shoe and the ground when lever 10 is in the ‘down’ position. This position is illustrated, by definition, in FIG. 4a. In this embodiment, the member 16 is a ‘push-pull rod’ i.e. flexible but non-compressible rod or strip that serves both ‘push’ and ‘pull’ functions. As illustrated, this enables opposing changes in the state of lever 10, and hence the locomotion-assisting spring, via both plantarflexion and dorsiflexion of the foot.

FIG. 5 illustrates a fourth embodiment of the invention. This embodiment utilizes a body location on the hip as well as a body location on the hindfoot. For simplicity, FIG. 5 omits the generalized switch 10, as well as some features of the previous figures such as the coupling 11 and cam 18. Shown is a long ‘push-pull rod’ 16. At its lower end, the push-pull rod is constrained by rod housings 15, 17 which are similar to those in the previous figures. Also shown is an upper rod housing 19 secured to the user's waist. Unlike the previous figures, plantarflexion and dorsiflexion of the foot do not play an important role in the embodiment of FIG. 5. Here instead, knee flexion i.e. lifting the whole foot and lower leg is used to induce forces on the push-pull rod and to change the state of the generalized switch (not illustrated) which is preferably located near the hindfoot location.

### DETAILED DESCRIPTION OF THE INVENTION

For illustrative purposes, body locations on the foot and leg are shown in all the figures. However the invention in its general form can employ other body locations.

Similarly, the mechanical linkages and mechanisms illustrated in the figures are simplified in order to focus on the fundamental aspect of invention, which relates to human body mechanics. Practical embodiments of the invention may employ additional mechanical elements and mechanisms, such as chains, ropes, cables, pulleys, hinges, conduits, pistons, gears, pinions, adjustment knobs, etc. in order to optimize the operation of the invention and to ensure user comfort.

The invention, in its most general form, is a mechanical linkage that is established between a first location on a user's body and a second, different location on the user's body, the mechanical linkage also being coupled to a wearable or otherwise body-borne switch (in the generalized meaning described above) and in such a manner that a specific body gesture induces a force on the mechanical linkage and actuates the switch.

The locations on the body may be established with the aid of wearable artifices such as shoes, helmets, pads and clothing and may be further stabilized with the aid of straps, pads, harnesses and the like.

The invention can be implemented on many different body parts. To simplify the description, it will be described by reference to the foot-based and leg-based embodiments shown in the figures. These embodiments provide a means to actuate a foot-borne switch (latch, lever etc.) by way of a foot or a leg gesture i.e. by the user choosing to take a specific orientation of the foot or leg.

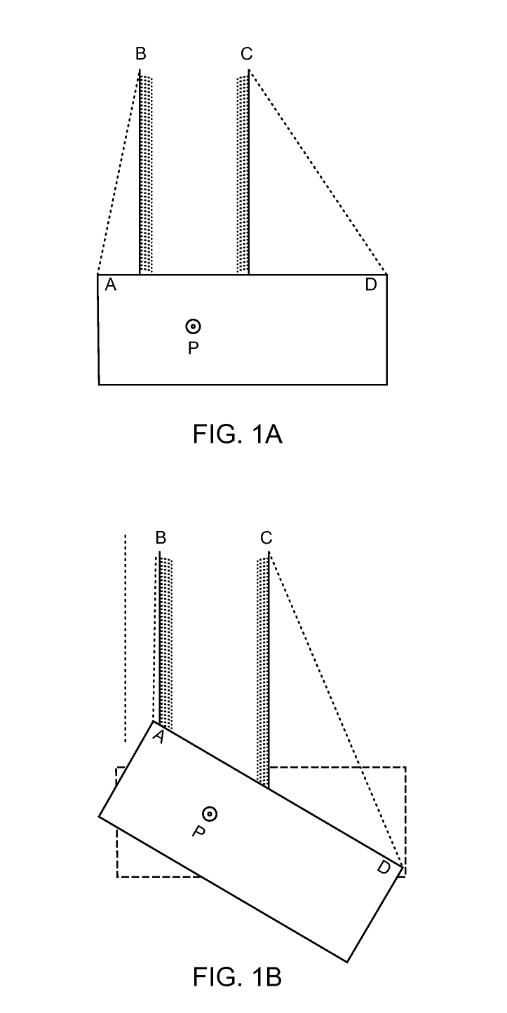

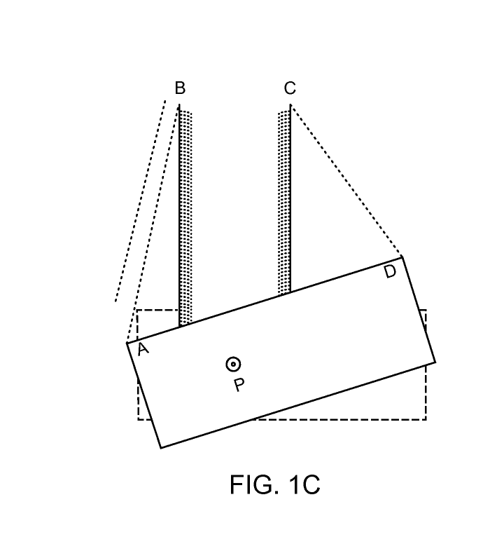

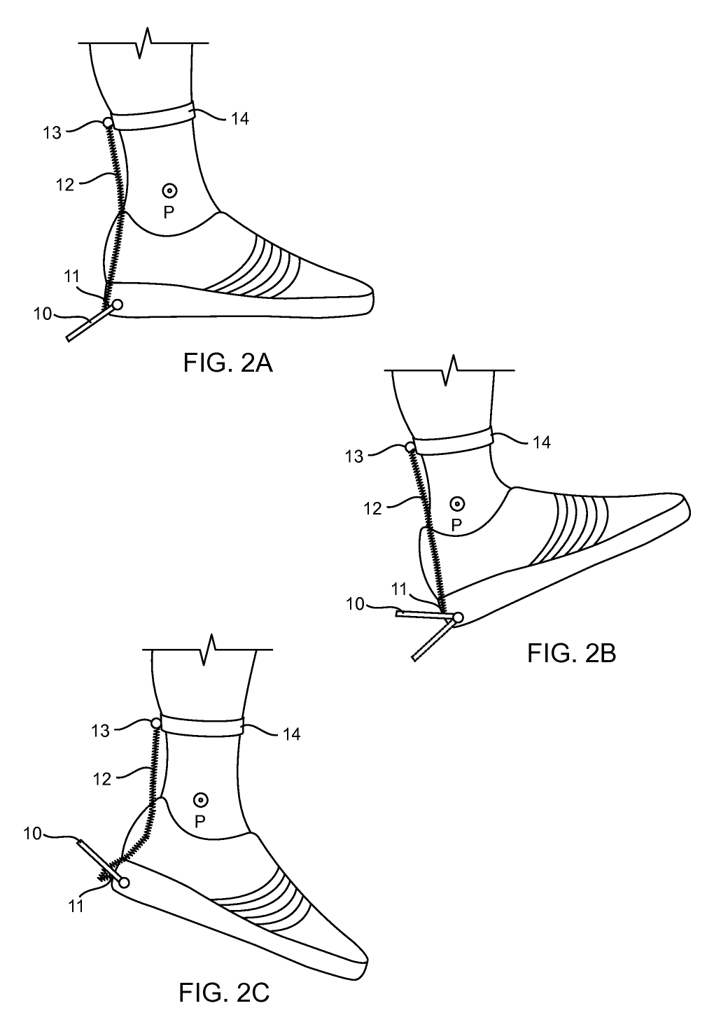

The invention requires a direct mechanical linkage between two locations on the user's body. In the case of the illustrative foot-based embodiments, one location is on the user's hindfoot and the other on the user's ankle, lower leg, or hip. Specific foot gestures create changes in the distance between the two locations, thus creating a force on the mechanical linkage between them, the force acting upon the switch. Examples of the geometric principles that cause the abovementioned changes of length will be discussed by reference to FIG. 1 and further referenced through FIGS. 2, 3, 4, and 5 showing the illustrative, foot-based and leg-based embodiments of the invention.

FIG. 1a shows a highly simplified model of a leg and foot, standing at rest. Location A corresponds to a point near the heel; location B corresponds to the back of the leg; location C corresponds to the front of the leg, and location D, to the front (toe) of the foot.

The point ‘P’ represents a pivot location about which the foot rotates relative to the leg. In the human body, the pivot is located at or near the medial malleolus i.e. the bony protuberance on the inside of the ankle. The pivot location on the human foot is approximately illustrated in FIGS. 2, 3, and 4 as point ‘P.’

Shown in dotted lines in FIG. 1a are the line segments AB and CD. FIG. 1b is an analog of plantarflexion of the foot, i.e. pointing of the forefoot downward and away from the knee and shin. As can be seen by comparing FIGS. 1a and 1b, the distance AB shortens in plantarflexion while the distance CD lengthens. For ease of comparison, a line segment equal in length to the resting length of AB (seen in FIG. 1a) is shown beside the slightly lesser length line segment AB of FIG. 1b.

FIG. 1c illustrates dorsiflexion of the foot, i.e. pulling the forefoot upward, toward the knee and shin. As can be seen by comparing FIGS. 1a and 1c, the distance AB lengthens in dorsiflexion while the distance CD shortens. For ease of comparison, a line segment equal in length to the resting length AB (seen in FIG. 1a) is shown beside the slightly longer segment AB of FIG. 1c.

Together, the FIGS. 1a, 1b, and 1c illustrate the basic geometry that occurs in the foot during lifting and lowering of the forefoot i.e. dorsiflexion and plantarflexion. As illustrated in the figures, due to this geometry, dorsiflexion and plantarflexion can create changes in the distance between pairs of locations on the user's foot and leg. Note by contrast that the distance between any other pair of locations for which both points are on the foot (i.e. shoe), as for example in the case of line segment AD, is gesture-independent.

It should be understood that FIG. 1 is illustrative and exemplifies the invention which has application beyond the illustrated embodiments. The invention in its full generality may utilize other locations on the foot as well as other foot gestures. Furthermore, the invention may include body locations other than the foot and leg.

FIG. 2 illustrates a first embodiment of the invention in which a bi-stable, lever-type switch, situated near the heel of the user's shoe can be changed from a ‘down’ orientation to an ‘up’ orientation by dorsiflexion of the user's foot. In this embodiment, the invention utilizes the phenomenon of the lengthening of the distance AB seen in FIG. 1c.

In FIGS. 2a, 2b, and 2c, there is shown a bi-stable, lever-type switch 10 located near the heel of the user's shoe. The switch is coupled via coupling 11 to a flexible mechanical linkage in the form of a chain or rope 12, which is, in turn, connected to location 13 on the user's upper ankle. Location 13 is stabilized with strap 14 which circumscribes the user's leg.

FIG. 2a, illustrates the condition of standing at rest. The switch happens to be in the ‘down’ position.

FIG. 2b illustrates dorsiflexion of the user's foot. In this case, the distance between the locations 10 (or 11) and 13 and is increased, tension is induced in the chain or rope 12, thus pulling the lever into the ‘up’ position. The switch is therefore actuated from ‘down’ to ‘up’ by dorsiflexion of the user's foot.

FIG. 2c illustrates plantarflexion of the user's foot. The figure illustrates that this gesture has no effect on the switch state but merely increases the slack in the flexible linkage 12.

The point ‘P’ seen in FIGS. 2a, 2b and 2c represents the foot's pivot point which is approximately located near the medial malleolus.

The embodiment of the invention illustrated in FIG. 2 is very simple and is meant to illustrate the most fundamental aspects of the invention. Additional subsystems, not included in the figures may be added in order to optimize a device of the invention. For example, although not illustrated in FIG. 2, it would be convenient for the fastening that connects the chain 12 to the location 13 to possess a fine adjustment means. This would enable the user to manually adjust the chain length in order to ensure that a small amount foot dorsiflexion that occurs during ordinary walking does not trigger the switching action while, at the same time, ensuring that a full dorsiflexion (i.e. a concerted, lifting of the forefoot by the user) does indeed trigger the switch.

Similarly, other contrivances that are not illustrated in FIG. 2 such as springs, hinges, or sliding contacts are contemplated and may be used to optimize the operation of this embodiment.

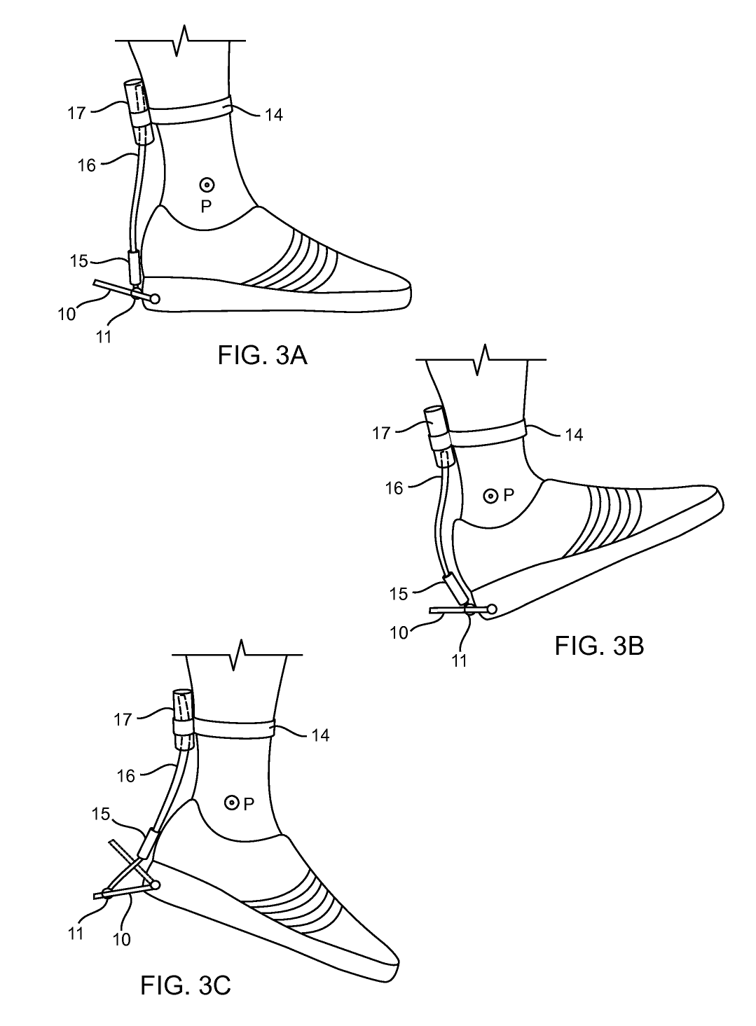

FIG. 3 illustrates a second embodiment of the invention in which the same basic geometry seen in FIG. 2 can be used to change the switch from the ‘up’ orientation to the ‘down’ orientation via plantarflexion of the user's foot. This embodiment utilizes the phenomenon of the shortening of the distance AB seen in FIG. 1b.

In FIGS. 3a, 3b, and 3c, there is switch 10, coupled via a coupling 11 to a mechanical linkage in the form of a flexible but non-compressible strip or push rod 16. Suitable materials include steel strip, or fiberglass rod (the latter of approximately 1/16″ diameter). The push rod is inserted within tubular housings 15 and 17 which serve to restrain the lateral (radial) motion of the push rod while allowing lengthwise i.e. vertical (axial) motions.

Housing 15 is open at both ends and helps to keep the push-rod in proper position for coupling of the push rod to the switch 10 via coupling 11. Housing 17 is closed at the top to provide an upper limit to the vertical axial travel of the push rod. Housing 17 is secured to the user's upper ankle by strap 14.

In FIG. 3a, the user is standing at rest and switch 10 is in the ‘up’ position. Note from this figure that the push rod has total length approximately equal to the total distance between the top of housing 17 to the upper surface of switch 10 when the switch is in the ‘up’ position and the user is standing at rest. This ensures that when the user is at rest, the push rod exerts little or no force on the switch.

With the push rod so configured, dorsiflexion has no effect on the switch because the push rod is free to travel unhindered toward the bottom of the tubular housing 17. This is illustrated in FIG. 3b. As shown in the figure, the relative lengths of the push rod and the housing 17 are configured so that the push rod has sufficient length to remain within the housing during dorsiflexion.

FIG. 3c illustrates that during plantarflexion of the user's foot, the push rod 16 is forced to abut against the upper, closed end of housing 17. Compressive forces are induced in the push-rod, causing the lower end of the push-rod to extend under the bottom of housing 15, thus pushing the switch downward and forcing the switch from the ‘up’ to the ‘down’ position.

The point ‘P’ seen in FIGS. 3a, 3b and 3c represents the foot's pivot point which is approximately located near the medial malleolus.

FIG. 3 also illustrates a simple embodiment of the invention. It is possible to include additional components and sub-mechanisms, not shown in the figures, in order to optimize the operation of a device of the invention. As a first example, although not illustrated in FIG. 3, a spacer can be included in the strap 14. The spacer would position housing 17 away from the leg, in the rearward direction, in order to reduce the total curvature of the push rod.

As a second example, a hinged coupling 11 may be implemented between the push rod and the switch 10. This would allow the push rod to lift off the switch in conditions of dorsiflexion (FIG. 3b) thus allowing an alternative means for the push rod to travel during dorsiflexion.

A third example of an artifice that is not illustrated in FIG. 3 relates to the top of housing 17. This may be fitted with an adjustable spacer or screw whose function is to adjust the effective height of the inside upper portion of housing 17, enabling the user to make manual, fine adjustment to the push-rod system. In this way, small amounts of plantarflexion, as needed for ordinary walking, would not trigger the switch, while, at the same time, a full plantarflexion i.e. a concerted downward extension of the forefoot by the user would indeed trigger the switch. Similarly, the push rod may be coupled to an extension spring connected to the upper limit of housing 17 or coupled to a compressive spring connected to the upper limit of housing 15. This would ensure that the push rod tends to automatically retreat to the upper range of its travel after an incidence of plantarflexion, thus ensuring that the push rod does not interfere with the normal use of the user's foot in the times between plantarflexion.

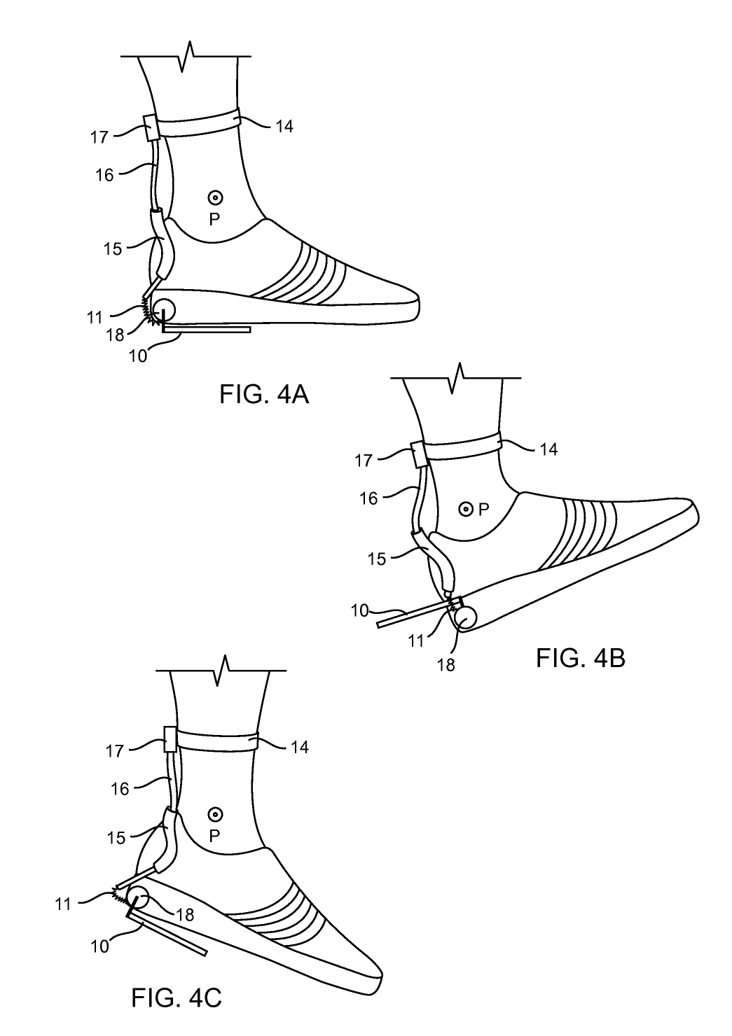

FIG. 4 illustrates a third embodiment of the invention in which the same body locations as seen in FIGS. 1 and 2 can be used to change a switch from the ‘up’ orientation to the ‘down’ orientation via plantarflexion of the user's foot and, the same embodiment can be used to change the switch from ‘down’ to up′ via dorsiflexion of the user's foot. This embodiment utilizes both phenomena of the shortening and lengthening of the distance AB as seen in FIG. 1b and FIG. 1c.

The embodiment of FIG. 4 utilizes a push-rod of the same type as in FIG. 3 but in this embodiment, it is named ‘push-pull rod’ because it serves both ‘push’ and ‘pull’ functions. One end of the push-pull rod 16 is attached to of a flexible coupling 11 such as a short length of chain, that connects the end of the push-pull rod to cam 18. The other end of push-pull rod 16 is attached to housing 17. Unlike the embodiment of FIG. 3, the topmost end of the push-pull-rod 16 of FIG. 4 is permanently fixed in place within the top of housing 17.

FIG. 4b illustrates how dorsiflexion of the user's foot causes the lower portion of the push-pull rod 16 to retract into the lower end of housing 15, thus exerting a force on the coupling 11 and cam 18 which causes the switch 10 to orient into the ‘up’ position.

FIG. 4c illustrates how plantaflexion causes the lower portion of the push-pull rod 16 to extend beyond the lower end of the housing 15 and thus exert a force on coupling 11 and cam 18 which causes the switch 10 to orient into the ‘down’ position.

The push-pull rod is housed within tubular housings 15 and 17 which serve to restrain the lateral (radial) motion of the push rod while allowing lengthwise i.e. vertical (axial) motions, and to ensure that the push-pull rod is configured in an orientation conducive to coupling with the switch.

Housing 15 is open at both ends and helps to keep the push-rod in proper position for coupling of the push rod to the switch 10 via coupling 11. Housing 17 is closed at the top and push-pull rod 16 is fixed permanently to the inside top of housing 17. Housing 17 is secured to the user's upper ankle by strap 14.

In FIG. 4a, the user is standing at rest and the switch is in the ‘down’ position. With the push rod so configured, dorsiflexion causes push-pull rod 16 to retract within housing 15 and to thus exert forces on coupling 11 and cam 18 so that the switch is pulled into the ‘up’ position.

FIG. 4c illustrates that during plantarflexion of the user's foot, the push-pull rod 16 is forced to extend out of the bottom of housing 15, thus exerting a force on coupling 11 and cam 18 that forces the switch from the ‘up’ to the ‘down’ position.

When properly configured, the flexible coupling 11 allows some small amount of play to occur in the system. In other words, small foot motions, such as those that occur during ordinary walking and which cause relatively small motions in the end of the push-pull rod 16, do not cause changes in the switch because the slack in coupling 11 prevents significant forces to be transferred to the cam and switch.

The point ‘P’ seen in FIGS. 4a, 4b and 4c represents the foot's pivot point which is approximately located near the medial malleolus.

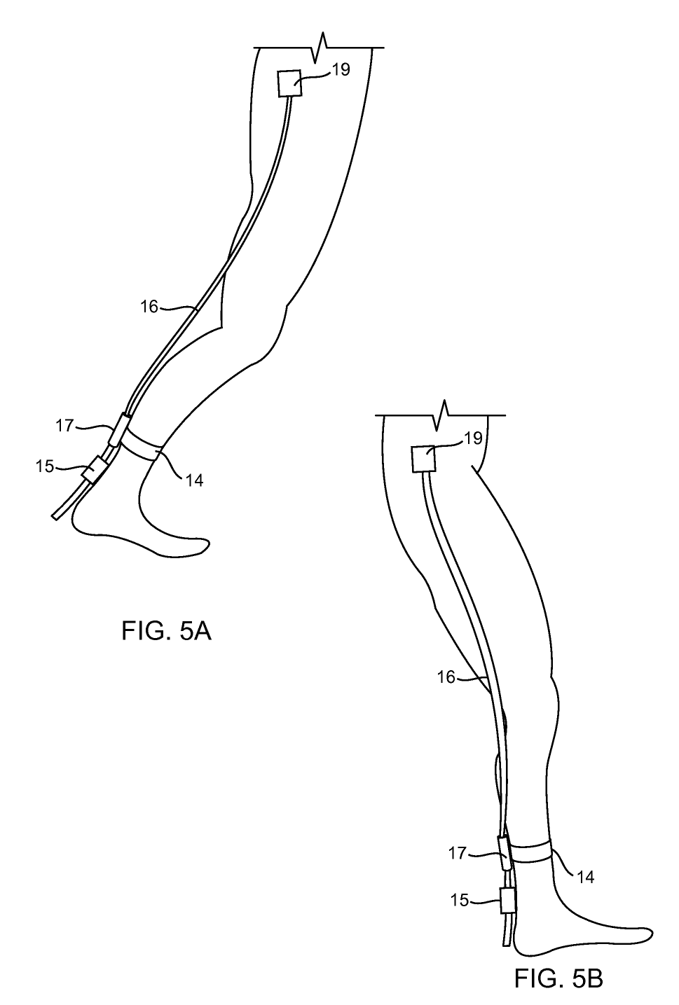

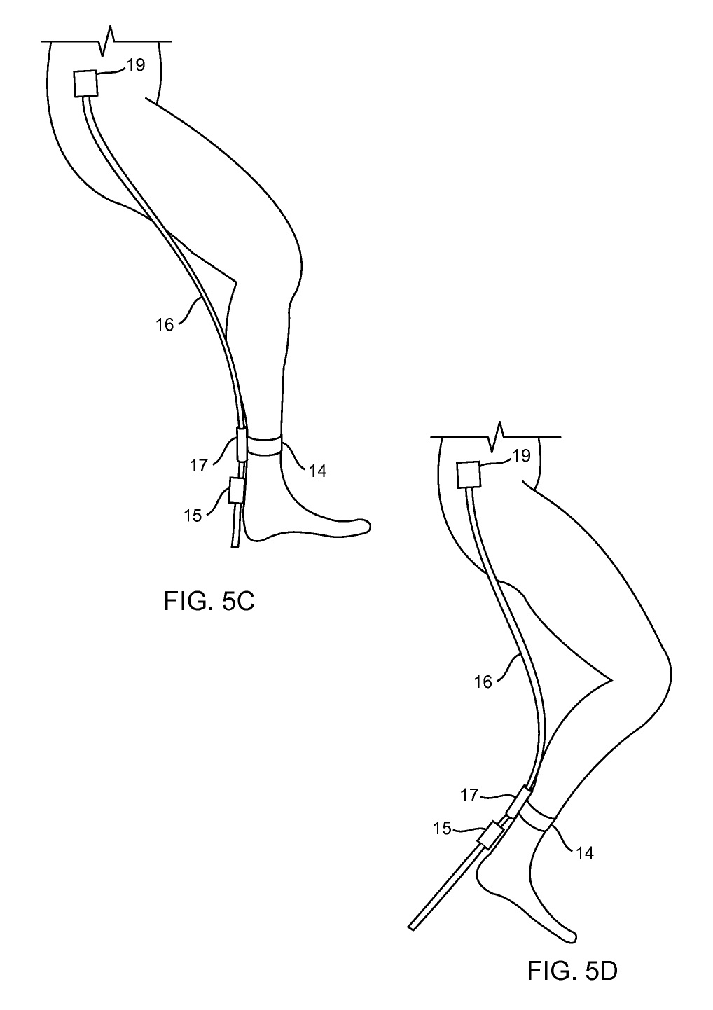

FIG. 5 illustrates a fourth embodiment of the invention in which a whole-leg gesture is used to generate forces on a mechanical linkage 16. In this embodiment linkage 16 is terminated at the lower end, near the user's foot, and at the higher end, at the user's waist, near the hip.

As before, the ultimate aim is to change the state of a generalized switch located at the user's foot. However, for simplicity, the generalized switch is not shown in FIG. 5. This is because the previous figures illustrate that suitable switch mechanisms can be designed in such a way as to harness the gesture-induced forces in linkage 16 to cause either ‘up-to-‘down’ state changes or ‘down-to-‘up’ state changes or both.

When properly configured, the flexible coupling 11 allows some small amount of play to occur in the system. In other words, although small foot motions such as those that occur in ordinary walking do cause small motions in the end of the push-pull rod 16, such small motions do not cause changes in the switch orientation because the slack in coupling 11 prevents forces to be transferred to the cam and switch.

Similarly to the previous embodiments, the embodiment of FIG. 5 comprises housing 15 located at the hindfoot which can be conveniently built into the back of the user's shoe. Also shown is an optional housing 17 located at the ankle or the upper portion of the back of the user's shoe.

In addition, the present embodiment comprises housing 19 near the user's hip, which has no direct counterpart in the previous figures. Analogously to the embodiment of FIG. 4, however, the topmost end of the push-pull-rod 16 of FIG. 5 is permanently fixed within the topmost housing 19.

FIGS. 5a, 5b, and 5c illustrate how leg configurations used in ordinary walking do not cause appreciable extension of the lower portion of the push-pull rod 16 beyond the lower end of housing 15.

FIG. 5d illustrates how flexion of the knee, resulting in a raising of the lower leg, causes the lower portion of the push-pull rod 16 to extend beyond the lower end of housing 15. The associated forces can be used to actuate appropriate couplings, cams, levers etc. in order to causes a generalized switch on the user's shoe, to change state.

The embodiment of FIG. 5 can be easily modified to enable a manual mode of operation, in which the user can choose to manually exert forces on the push-pull rod, thus affecting changes in state of the generalized spring without the knee flexion gesture. This may be implemented, for example, by providing a manual means to release the push-pull-rod 16 from housing 19.

The above detailed descriptions along with their referenced figures illustrate lever-type switches that are positioned near the heel of the user's shoe or on the leg. In addition, each switch is configured so that its two distinct orientations can be achieved via more-or-less vertical displacements of the lever. This can be useful because, as seen in FIGS. 2, 3, and 4, the switch ‘up and ‘down’ orientations can be affected by corresponding ‘up’ and ‘down’ gestures of the forefoot (i.e. dorsiflexion and plantarflexion respectively). In these cases, the operation of the switch is intuitively obvious to the user. This is especially advantageous when the switch of the invention is coupled to a movable shoe spring that needs to be oriented downward in order to engage with the ground (and thus provide spring-assisted locomotion) as well as oriented upward to disengage with the ground (and thus allow normal use of the foot and shoe).

The invention can be used together with a movable, shoe-borne spring assembly. The spring assembly is intended to enhance the efficiency, ergonomics, and entertainment value of human foot-based locomotion. In particular, the movable spring assembly has ‘down’ and ‘up’ positions and is particularly suited for skateboarding, with the spring ‘down’ when the user's foot performs a power-stroke against the ground, and with the spring ‘up’ when the same foot is brought to rest on the skateboard surface or when the user is not skateboarding and wishes to use the shoe for normal locomotion.

The present invention, when coupled with the moveable spring assembly, allows the user to quickly and easily change the position of the spring either ‘down’ or ‘up’ by executing corresponding ‘down’ or ‘up’ gestures of the forefoot. Note however that a specific ‘up-down’ or vertical switch orientation is not necessary for the invention, which is more general.

Similarly, the embodiments shown in FIGS. 2 3, and 4 show the same pair of locations with one location on foot and the other on ankle. Variants of the invention are contemplated using points on the front of the foot and the front of the leg. One such variant is shown in FIG. 5.

The mechanisms illustrated in the figures, although fully functional and practical, have been simplified for illustrative purposes. These in no way limit the generality of the invention. For example, it is possible to use any number of mechanical contrivances such as springs, pulleys, hinges, sliding contacts, latches, conduits and triggers etcetera, in any number of configurations in order to achieve optimized functionality of the invention.

The invention in its most general form includes any body locations and any switch systems that are configured via appropriate mechanical couplings to cause the mechanical actuation (i.e. change of state) of the body-borne switch via a specific body gesture.

The invention includes any device that uses the relative change in distance between any two locations on the human body and that are incurred during specific body motions to effect the actuation of a mechanical system located on the body. Therefore the invention applies to any body part and appendage such as hands, arms, neck, and shoulders.

An advantage of the invention is that the user can easily and quickly change the state of the body-borne switch without the need for direct manual manipulation of the switch. This allows the user to actuate the switch while performing other activities.

An advantage of the invention is that the mechanical forces generated by the body are directly involved in the actuation of the mechanical system (i.e. switch), without the need for special sensors, inertial devices, motors, batteries, processors or the like, that are otherwise required to detect body gestures and act thereupon.

The invention may be used in robotic prosthesis, appendages, and protective suits, in order to actuate switches that turn on or turn off specific subsystems. The invention may be useful to those who lack fine motor skills and who are incapable of manipulating conventional switches. This includes amputees, stroke victims and the like. For such people, the invention allows for a coarse body gesture to perform an otherwise fine function such as the actuation of a small switch.

Advantageously, no motion sensors, computer processors, gesture detectors, electronics, batteries, etc are needed. Instead the invention enables body-generated forces to act more-or-less directly on the switch.

Possible applications of the invention include the use of a foot gesture to change the state of a foot-borne mechanical system such as a moveable spring that is designed to assist locomotion, the use of an arm or hand gesture to turn on or off a wearable electronics tool such as a headlight, a wireless communication device, or an alarm device, the use of an arm gesture, such as the straightening of an arm, in order to turn on a body-borne light, the use of a leg gesture, such as the lifting of a knee, in order to turn on an internal cooling system of a protective suit, the use of a foot gesture to control the speed of a hand-held device such as a drill, the use of a hand gesture to control a wheelchair motor, and the use of an arm gesture to actuate a remote-control system such as television remote control. Other uses are contemplated.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are within the meaning and range of equivalents of the disclosed embodiments, based on the teaching and guidance presented. The phraseology or terminology is for description and not of limitation, such that the terminology or phraseology of the present specification is interpreted by the skilled artisan in light of the teachings and guidance. The breadth and scope of the present invention should not be limited by the above-described exemplary embodiments, but should be defined only under the following claims and their equivalents exemplary embodiments, but should be defined only under the following claims and their equivalents.

1. A body-borne switch system comprising:
a switch coupled to and extending from a first body part;
a mechanical linkage coupled to the switch on one end and to a second body part on the other end, the two body parts separated by a fixed length at a resting position and located on either side of a pivot point;
the switch configured to move from a first position to a second position as a gesture on at least one body part causes the length separating each body part to increase or decrease.
